(19) United States
(12) Patent Application Publication
(10) Pub. No.: US 2007/0093919 A1
(43) Pub. Date: Apr. 26, 2007

(54) REMOTE CONTROL SYSTEM FOR TUBS

(76) Inventors: Dominique CIECHANOWSKI, Sainte-Marguerite de Dorchester (CA); Miguel Castellote, Sainte-Marguerite de Dorchester (CA); Michel Lafrance, Levis (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/551,366

(22) Filed: Oct. 20, 2006

Related U.S. Application Data
(60) Provisional application No. 60/728,318, filed on Oct. 20, 2005.

(51) Int. Cl. G05B 19/18

(52) U.S. Cl. 700/65; 700/66

(57) ABSTRACT

A remote control system in combination with an electrically actuated tub system. The remote control system has an electrically actuated tub system in association with a tub/tub surroundings. The electrically actuated tub system has an apparatus controlled by an apparatus controller through a user interface keypad. A remote control is adapted to send command signals. A receiver detects signals from the remote control. A control interface is connected to the receiver to receive the command signals from the remote control, and is connected to the apparatus controller to actuate the apparatus controller into controlling the apparatus as a function of the command signals from the remote control.

### CROSS-REFERENCE TO RELATED APPLICATION

This patent application claims priority on U.S. Provisional Patent Application No. 60/728,318, filed on Oct. 20, 2005, by the present applicants.

### BACKGROUND OF THE INVENTION

1. Field of the Invention

The present invention generally relates to washing/bathing tub accessories and, more particularly, to a remote control system to be used in conjunction with electrically-actuated tub systems provided with tubs, bathtubs, spas, pools, etc, such as air massage systems, whirlpool systems, oxygenation systems and the like.

2. Background Art

Tubs are well known for their primary use, namely a washroom installation in which a user person washes and bathes. Tubs have however evolved to add relaxation and comfort to practicality, and are found in many forms, such as bathtubs, spas, whirlpools.

For instance, tubs are now provided with air-jet systems and whirlpool systems, by which air or water is injected into the water of the tub to create some turbulence in the water. The turbulence creates a massaging effect on the bather in the tub. Other types of electrically actuated systems, such as oxygenation systems, foot massage systems and aromatherapy systems are provided in conjunction with tubs, whereby a plurality of treatments are available with tubs.

The bather having recourse to such treatments seeks amongst other things a moment of relaxation. In the evolution of the tubs to provide additional functionality, the bathing room environment has also changed to become an oasis of relaxation. For instance, to soothe the senses of the bathers, audio-visual systems, such as media players (e.g., CD players) are often provided in bathing rooms. Such systems are kept at a distance from the tubs in order to lessen the risks of electrical hazards. Considering the numerous systems found in bathing rooms, it is therefore desired to simplify the use of all such systems to ensure that the bather benefits from relaxing in the tub.

### SUMMARY OF INVENTION

It is therefore an aim of the present invention to provide a novel remote control system associated with electrically actuated tub systems.

Therefore, in accordance with the present invention, there is provided a remote control system in combination with an electrically actuated tub system, comprising: an electrically actuated tub system in association with a tub/tub surroundings, the electrically actuated tub system having an apparatus controlled by an apparatus controller through a user interface keypad; a remote control adapted to send command signals; a receiver detecting signals from the remote control; a control interface connected to the receiver to receive the command signals from the remote control, and connected to the apparatus controller to actuate the apparatus controller into controlling the apparatus as a function of the command signals from the remote control.

A remote control system (i.e., RCS) is added to an existing whirlpool system, an air massage system, or the like.

The remote control itself may be stored on the tub wall using a magnetic holding support installed on the tub wall in addition to magnets positionned in the remote control.

Feedback coming from the apparatus controller is visually displayed on the original keypad mounted on the tub wall and/or the remote control (LED, LCD, etc).

The remote control and the transmitter/receiver module (TRM) preferably use RF communication.

### BRIEF DESCRIPTION OF THE DRAWINGS

Having thus generally described the nature of the invention, reference will now be made to the accompanying drawings, showing by way of illustration a preferred embodiment thereof and in which:

FIG. 1 is a block diagram view of a remote control system in accordance with an embodiment of the present invention, as associated with a tub system;

FIG. 2 is a perspective view of a remote control of the remote control system of FIG. 1, in accordance with another embodiment of the present invention;

FIG. 3 is a top plan view of the remote control of FIG. 2; and

FIG. 4 is a bottom plan view of the remote control of FIG. 2.

### DESCRIPTION OF THE PREFERRED EMBODIMENTS

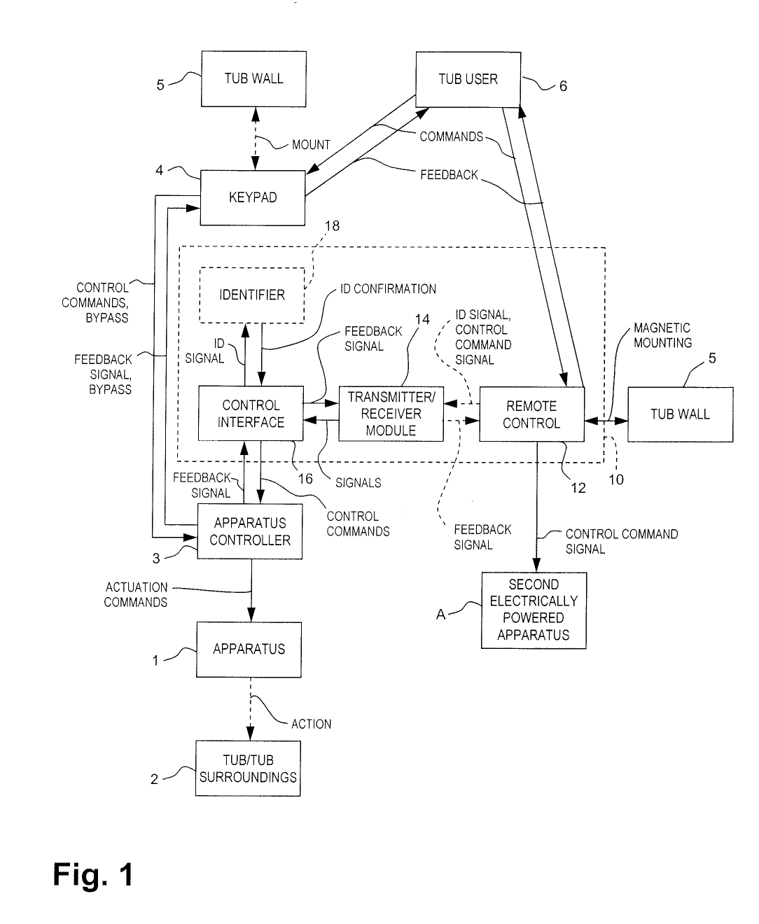

Referring now to the drawings and, more particularly, to FIG. 1, a remote control system for tubs in accordance with a preferred embodiment is generally shown at 10. The remote control system 10 is associated with an electrically-actuated tub system.

The remote control system 10 of FIG. 1 is shown associated with a tub system having an apparatus 1. The apparatus 1 is electrically actuated and is provided in the vicinity of a tub 2, so as to perform an action associated with the tub. The apparatus 1 may be a part of a plurality of electrically actuated systems such as whirlpool system, oxygenation systems, or the like. For instance, the apparatus 1 is a blower that is part of an air massage system injecting air into the liquid contained in the tub.

The apparatus 1 is typically associated with an apparatus controller 3. The controller 3 is typically a processor receiving control commands from a keypad 4, and transmitting actuation commands to the apparatus 1. The controller 3 is typically integrally formed as part of the apparatus 1. For instance, the apparatus 1 has a blower, which has a casing to incorporate the controller 3. The keypad 4 is in the vicinity of the tub. In an embodiment, the keypad 4 is embedded in the tub wall 5 (e.g., on a peripheral ledge or flange of the tub). Accordingly, a tub user 6 actuates the tub system through the keypad 4.

The remote control system 10 has a remote control 12, a transmitter/receiver module 14 (i.e., TRM) and a control interface 16. An identifier is optionally provided, in association with the control interface 18. The remote control 12 is provided as an interface between the tub user 6 and the apparatus 1 through the remote control system 10, and is preferably provided with magnets so as to be mountable to the tub wall 5 (having corresponding magnets).

The transmitter/receiver module 14 is in remote communication with the remote control 12. The transmitter/receiver module 14 receives control commands (e.g., on/off, intensity control, actuation of optional systems or of various functions, etc.) from the remote control 12. The transmitter/receiver module 14 optionally returns feedback signals coming from apparatus controller 3 via the control interface 16 to the remote control 12.

The control interface 16 is connected to the original keypad 4 and to the transmitter/receiver module 14, and directs commands received through the remote control 12 to the apparatus controller 3. The control interface 16 converts signals from the transmitter/receiver module 14 to a suitable protocol to control the apparatus controller 3. The control interface 16 will therefore send control commands to the apparatus controller 3 for the actuation of the apparatus (e.g., whirlpool system, air-jet system, oxygenation system, aromatherapy system, foot massage system, or the like) associated with the tub, as a response to the input from the bather or operator using the remote control 12.

The control interface 16 is optionally associated with the keypad 4, so as to provide a feedback signal to the keypad 4 to indicate to the tub user 6 that the remote control commands have been received by the remote control system 10. The feedback signal may be visual, such as the lighting of keypad buttons, or auditive, such as a beeping sound from the keypad 4 or the apparatus 1.

The identifier 18 is optionally provided in the remote control system 10, in association with the control interface 16. The identifier 18 is provided to determine whether the signals received are from the remote control 12. If the identifier 18 is used, the control command signals sent by the remote control 12 are accompanied by an ID signal. The ID signal is specific to the remote control 12. Accordingly, the remote control system 10 is configured to receive signals from a specific remote control, which signals are confirmed by the identifier 18. The ID confirmation from the identifier 18 enables the control interface 16 to send control commands to the apparatus controller 3. Therefore, interfering signals (e.g., from RF signals from other remotes) will be filtered out by the identifier 18. It is pointed out that remote control systems 10 can be programmed to a specific ID of the remote control 12, such that remote controls can be replaced, for instance in the case of a defective remote control.

In an embodiment, the remote control system 10 consists of a retrofit kit which is installed on the existing system associated with the tub. For instance, the remote control system 10 is spliced or connected between the line connecting the keypad 4 to the apparatus controller 3. A bypass circuit is provided in the control interface 16 such that the apparatus controller 3 and the keypad 4 may communicate directly with one another, notwithstanding the retrofitting of the remote control system 10 between the apparatus controller 3 and the keypad 4.

Still referring to FIG. 1, the remote control 12 is illustrated as sending control command signals to an a second electrically powered system A, in an optional function of the remote control system 10. The second electrically powered system A may be any of another tub apparatus (e.g., for another tub), an audio/audiovisual system such as a music player (e.g., CD player, radio, etc.), a television set positioned in the bathing room at a distance from the tub.

As is well known, electrically powered systems such as audio/audiovisual systems are typically provided with wireless remote controls. The remote controls communicate with the equipment (e.g., CD player, television, etc.) using signals within standards of frequencies. Moreover, commands for given equipment are generally standard (e.g., PLAY, STOP, NEXT/PREVIOUS TRACK, FAST FORWARD, etc.). Therefore, there is some level of universality in the commands within the standards of frequencies used in remote controls.

Therefore, the remote control 12 optionally incorporates the necessary electronics to remotely command a second electrically powered system A such as audio/audiovisual systems according to standards of frequencies.

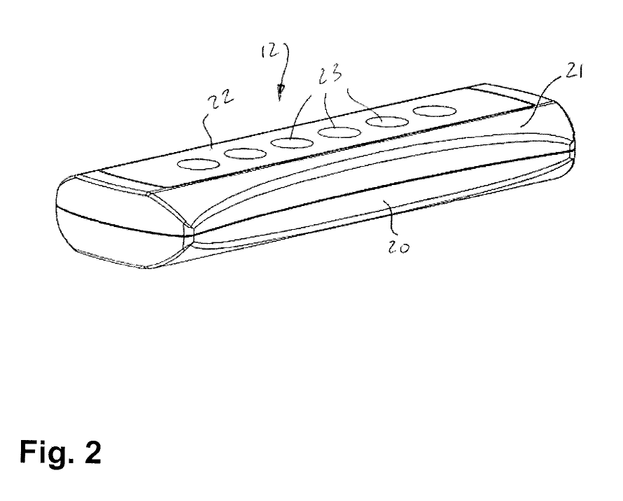

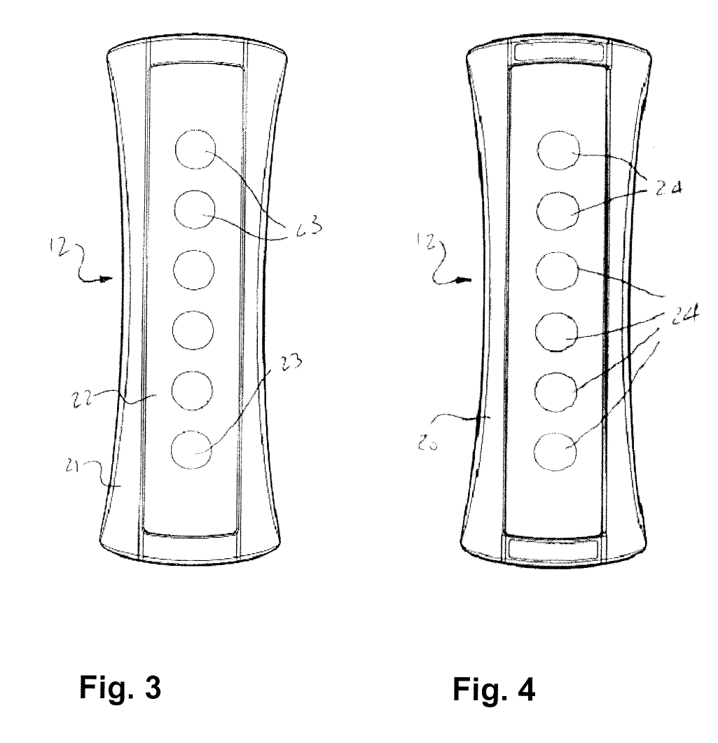

Referring concurrently to FIGS. 2 to 4, the remote control 12 is shown having a bottom shell 20 and a top shell 21. The bottom shell 20 and the top shell 21 are typically made of a plastic, and are shaped so as to be nested in a sealed relation, such that the contents of the shells 20 and 21 are encapsulated and isolated from water. Moreover, the interconnected shells 20 and 21 form a hollow cavity, whereby the remote control 12 floats.

The top shell 21 has a top surface 22 from which push buttons 23 protrude. Similarly, in the event that the remote control 12 is used to command a second electrically powered system A, such as an audio/audiovisual systems, the bottom shell has push buttons 24. The shells 20 and 21 enclose at least one printed circuit board (hereinafter PCB), that relates the push buttons 23 and 24 to an internal emitter/receiver (not shown). The PCB (not shown) is a control unit actuatable to emit signals. In an embodiment, the PCB emits RF signals whereby no emitter has to protrude from the shells 20 and 21. This reduces the risk of water penetrating the remote control 12. Accordingly, the user of the remote control 12 emits command signals for the apparatus 1 by pressing selected push buttons 23, and command signals for the second electrically powered system A by pressing selected push buttons 24.

The push buttons 23/24 are typically part of a membrane that lies on a portion of the PCBs, with the push buttons 23/24 being in register with associated components of the PCB. Accordingly, actuation of the push buttons 23/24 results in select signal emission by the internal emitter/receiver. A waterproof adhesive is typically used with the membrane to ensure the PCBs and other components within the shells 20 and 21 remain isolated from water. The push buttons 23/24 sealingly emerge out of the top shell 21/bottom shell 20, respectively, whereby the remote control 12 is submersible.

The remote control 12 is preferably modular, as it is considered to provide the remote control 12 with more than one PCB/emitter system. FIGS. 2 to 4 illustrate the remote control 12 as having a pair of emitters to be used with two different receivers (i.e., apparatus 1 and system A). For instance, the remote control 12 could have three or more independent emitters (with associated PCB or like electronics). A remote control 12 configured to be used for three different systems is provided with 3 sets of push buttons on three different faces of the modular remote control, etc.

The remote control 12 and the transmitter/receiver module 14 are selected so as to operate within a non-negligible area. For instance, it is contemplated to equip the remote control 12 and the transmitter/receiver module 14 with components suitable for remote communication at a distance of 2 meters from one another. Smaller or larger distances are also contemplated.

In an embodiment, the transmitter/receiver module 14 is received on a peripheral flange of the tub. The wires interconnecting the transmitter/receiver module 14, the apparatus controller 3 and the keypad 4 to the control interface 16 are hidden under the tub.

It is contemplated to use a powerless remote control 12 with the remote control system 10. It is known that such powerless remote controls do not have any power supply, and are triggered to change a frequency signal emitted by the transmitter/receiver module 14. Alternatively, the remote control 12 has a sealed battery inside. In such a case, it is considered that the remote control 12 be disposable once the battery is dead.

A support bracket is also provided in the vicinity or on the tub, so as to accommodate the remote control 12 when the latter is not being used. Alternatively, opposite magnets can be provided in the remote control 12, and in the tub wall, for releasably securing the remote control 12 to the tub wall. The magnets are typically connected to a hidden surface of the tub wall.

We claim:

1. A remote control system in combination with an electrically actuated tub system, comprising:
an electrically actuated tub system in association with a tub/tub surroundings, the electrically actuated tub system having an apparatus controlled by an apparatus controller through a user interface keypad;
a remote control adapted to send command signals;
a receiver detecting signals from the remote control;
a control interface connected to the receiver to receive the command signals from the remote control, and connected to the apparatus controller to actuate the apparatus controller into controlling the apparatus as a function of the command signals from the remote control.

2. The combination of claim 1, wherein the remote control has at least one magnet, so as to be magnetically connected to another magnet associated with a wall of the tub.

3. The combination of claim 1, wherein the control interface is spliced between the user interface keypad and the apparatus controller.

4. The combination of claim 3, wherein the remote control system is retrofitted to the electrically actuated tub system.

5. The combination of claim 1, further comprising a transmitter connected to the control interface, the control interface sending feedback signals through the transmitter to the remote control such that the remote control emits a visual or audible signal to confirm a command.

6. The combination of claim 1, wherein the control interface sends a feedback signal to the user interface keypad upon receiving a command signal from the remote control, the user interface keypad emitting a visual or audible signal to confirm reception of the command signal.

7. The combination of claim 1, further comprising an identifier associated with the control interface, the remote control sending an identification signal with command signals, such that the identifier validates the identification signal to allow the control interface to actuate the apparatus controller.

8. The combination of claim 1, wherein the remote control has circuitry enabling the remote control to send actuation signals to an alternative electrically powered system independently of the command signals to the control interface.

9. The combination of claim 1, wherein the remote has a plurality of emitters each independently associated with a different receiver.
